(19) United States
(12) Patent Application Publication
(10) Pub. No.: US 2014/0127541 A1
(43) Pub. Date: May 8, 2014

(54) CYLINDRICAL SECONDARY BATTERY AND BATTERY SYSTEM

(71) Applicants: Osamu Kubota, Tokyo (JP); Hironori Sanaki, Tokyo (JP)

(72) Inventors: Osamu Kubota, Tokyo (JP); Hironori Sanaki, Tokyo (JP)

(73) Assignee: Hitachi, Ltd., Tokyo (JP)

(21) Appl. No.: 14/127,343

(22) PCT Filed: Jun. 22, 2011
(86) PCT No.: PCT/JP2011/003554

§ 371 Date: Dec. 18, 2013

(51) Int. Cl. H01M 2/34

(52) U.S. Cl. CPC H01M 2/345
USPC 429/61

(57) ABSTRACT

A cylindrical secondary battery makes it possible to perform measurement of a battery voltage, and discharge, and to detect presence or absence of an actuation of an inner pressure sensitive current cutoff mechanism even after a battery inner pressure rises to actuate a current cutoff mechanism. In a cylindrical secondary battery having a pressure sensitive cleavage portion and a pressure sensitive current cutoff mechanism in a can lid, the can lid has at least two metal portions A and B insulated from each other and exposed from a battery inner side to a battery outer side. The metal portion A is electrically connected to an electrode winding body; and the metal portion B is not electrically connected to the electrode winding body before cleavage of the pressure mechanism A, and is electrically connected to the electrode winding body when the pressure mechanism A is cleaved.

### TECHNICAL FIELD

The present invention relates to a non-aqueous electrolyte type secondary battery whose battery container includes an electrode winding group formed by winding a strip-shaped positive electrode and a stripe-shaped negative electrode with a strip-shaped separator through which lithium ions can pass interposed between the electrodes.

The strip-shaped positive electrode is formed by applying to an electric collector a positive-electrode active material capable of discharging and accommodating lithium ions by charge and discharge The strip-shaped negative electrode is formed by applying to an electric collector a negative electrode active material capable of accommodating and discharging lithium ions by charge and discharge.

### BACKGROUND ART

A lithium ion secondary battery (hereinafter, a lithium ion battery) which utilizes storage and discharge of lithium ions in a charge and discharge reaction is widely expected as a power source for portable electronic apparatuses such as a cell phone and a laptop, a power source for time-of-disaster auxiliary, and a power source for mobile objects such as an automobile and a two-wheel vehicle for the following reasons. The lithium ion battery obtains a larger energy density than energy density of the conventional zinc battery or nickel-cadmium battery; since lithium contributing to the charge and discharge reaction is hardly precipitated as metal lithium on an electrode, the possibility that metal lithium drops off from the electrode to be deactivated is low, and for this reason, the lithium ion battery has a superiority in the reproducibility of a capacity when the charge and discharge are repeated; and for the same reason, stable charge-discharge characteristics can be obtained.

In this lithium ion battery, when thermal runaway is caused due to the reasons including overcharge and short-circuit, an inner pressure of the battery rises sharply due to cracked gas of an electrolyte and an electrode, or vapor of the electrolyte. Since the lithium ion battery having an extremely large inner pressure is ruptured by shocks from outside to scatter the contents around, care should be taken when handling the battery.

Here, a battery can lid is generally provided with a current cutoff mechanism which is actuated with a predetermined inner pressure, like the one, for example, described in a patent literary document 1. By the actuation of the current cutoff mechanism, a current is forcibly cut off to forcibly stop a chemical reaction within the battery, thereby preventing rupture or ignition of the battery.

However, as will be described below, there are problems in the lithium ion battery described above.

When the current cutoff mechanism is actuated, there will be no electrical contact between the electrode winding body and the can lid. The means to know the battery voltage will be lost thereby. This is a problem from the viewpoint of managing the battery state.

While the forced cutoff of current can prevent the further charge by the current cutoff mechanism for the chemical reaction within the battery, such a battery after the current cutoff mechanism has been actuated becomes high in dangerousness because the battery breaks down in a state more overcharged than a normal range of use of the battery. This is a problem from the viewpoint of securing the battery safety.

To solve these problems, a method of knowing the battery voltage and carrying out the discharge even after the current cutoff mechanism is actuated has been proposed.

For example, a method of interposing a high-resistance member portion which is substantially an insulating member between a current cutoff valve and an inner sealing plate electrically contacting a terminal plate is proposed in patent literary document 2. According to this method, after the current cutoff the measurement of a battery voltage through the high-resistance member portion can be carried out as well as the discharge.

A method of disposing a current cutoff mechanism and a diode in parallel between an inside of a cover or the cover itself and an electrode winding body is proposed in a patent literary document 3. This method utilizes the characteristics in which the diode can cause a current to flow only in one direction. Thus, the diode is installed in such a way that the current can be caused to flow only in a discharge direction of the battery, whereby a configuration is realized in which after the current cutoff mechanism has been actuated, the charge cannot be carried out, but the discharge can be carried out.

### PRIOR ART LITERATURE

### Patent Documents

Patent literary document 1: JP-H02-112151-A

Patent literary document 2: JP-2006-147180-A

Patent literary document 3: JP-2004-273139-A

### SUMMARY OF THE INVENTION

### Problem To Be Solved By the Invention

When the measures as described above are considered, there is still something to improve. That is to say, with the method of introducing the high-resistance member as described in the patent literary document 2, there is a drawback that the quick discharge cannot be carried out because the discharge of this method is carried out through the high-resistance member With the method of introducing the diode as described in the patent literary document 3, there is a drawback that the reliability is poor because failure in the diode cannot be detected from outside.

The current cutoff is also caused by the breakage of the electric collector tab in addition to the actuation of the inner pressure sensitive current cutoff mechanism. With those methods, the cause of the current cutoff of the battery can be made clear only after the battery is scrapped. Afterwards general users will not load the lithium ion battery that has undergone the current cutoff to the apparatus to use the battery. The cause of the current cutoff does not matter to the general users therefore. However, for battery manufacturers, the manufacturers preferably are able to figure out which of the causes has contributed to the current cutoff in consideration of the possibility of the battery reutilization, and the feedback for the battery development.

In the light of the foregoing, the present invention provides a cylindrical secondary battery and a battery system that make it possible to perform measurement of a battery voltage, and discharge, and yet whether an inner pressure sensitive current cutoff mechanism is actuated or not can be detected even after a battery inner pressure rises to actuate a current cutoff mechanism. The present invention also provides a battery system that is constructed by incorporating the cylindrical secondary battery.

### Means For Solving the Problems

According to one viewpoint of the present invention, there is provided a cylindrical secondary battery having a pressure sensitive cleavage portion (pressure mechanism A) and a pressure sensitive current cutoff mechanism (pressure mechanism B) in a can lid, the cylindrical secondary battery being characterized in that: the can lid has at least two metal portion A and metal portion B insulated from each other and exposed from a battery inner side to a battery outer side; the metal portion A is electrically connected to an electrode winding body; and the metal portion B is not electrically connected to the electrode winding body before cleavage of the pressure mechanism A, and is electrically connected to the electrode winding body when the pressure mechanism A is cleaved. Also provided is a battery system constructed by incorporating the cylindrical secondary battery.

Specifically, there are provided the cylindrical secondary battery characterized by having a current path A and a current path B within the battery, and the battery system constructed by connecting a discharging element such as a resistive element and a secondary battery to the cylindrical secondary battery.

The current path A is a current path through which the metal portion A and the electrode winding body are linked to each other and which is used in normal charge and discharge. The current path A also electrically contacts the electrode winding body before the pressure mechanism B is actuated, and does not electrically connect to the electrode winding body after the pressure mechanism B is actuated. The current path B is a current path through which the metal portion B and the electrode winding body are linked to each other and which is not used in the normal charge and discharge. The current path B does not electrically contact the electrode winding body before the pressure mechanism A is actuated, and electrically connects to the electrode winding body after the pressure mechanism A is actuated.

In addition, the battery of the present invention is characterized in that the pressure mechanism A is cleaved and the current path B is opened before the actuation of the pressure mechanism B. Therefore, the battery voltage can be detected in the current path B after the current cutoff is detected in the battery, which enables to detect whether the inner pressure sensitive current cutoff mechanism is actuated or not.

### Advantages of the Invention

Even after the pressure sensitive current cutoff valve is actuated, the measurement of the battery voltage, and discharge can be carried out. The present invention also enables to detect whether the pressure sensitive current cutoff mechanism is actuated or not.

### BRIEF DESCRIPTION OF THE DRAWINGS

FIG. 1 is a view explaining a can lid structure of a cylindrical battery.

FIG. 2 is a view explaining a shape of a first inner pressure sensing plate of the cylindrical battery.

FIG. 3 is a view explaining a shape of the first inner pressure sensing plate of the cylindrical battery.

FIG. 4 is a view explaining the shape of the first inner pressure sensing plate of the cylindrical battery.

FIG. 5 is a view explaining a can lid structure of the cylindrical battery.

FIG. 6 is a view explaining an electrode winding body of the cylindrical battery.

FIG. 7 is a view explaining a current path in a normal phase of the cylindrical battery.

FIG. 8 is a view explaining a current path in a phase of rise of an inner pressure of the cylindrical battery.

FIG. 9 is a view explaining a current path in the phase of the rise of the inner pressure of the cylindrical battery.

### MODE FOR CARRYING OUT THE INVENTION

Although the best mode for carrying out the invention will be described hereinafter based on specific embodiments, the present invention is by no means limited thereto. In addition, figures in the embodiment are schematic figures and do not guarantee the precision in information including positional relationship system and sizes in the figures.

A cylindrical secondary battery and a battery system according to the present invention will now be described.

### Making Can Lid

Since a core of the present invention lies in a can lid structure, the can lid structure will now be described especially in detail.

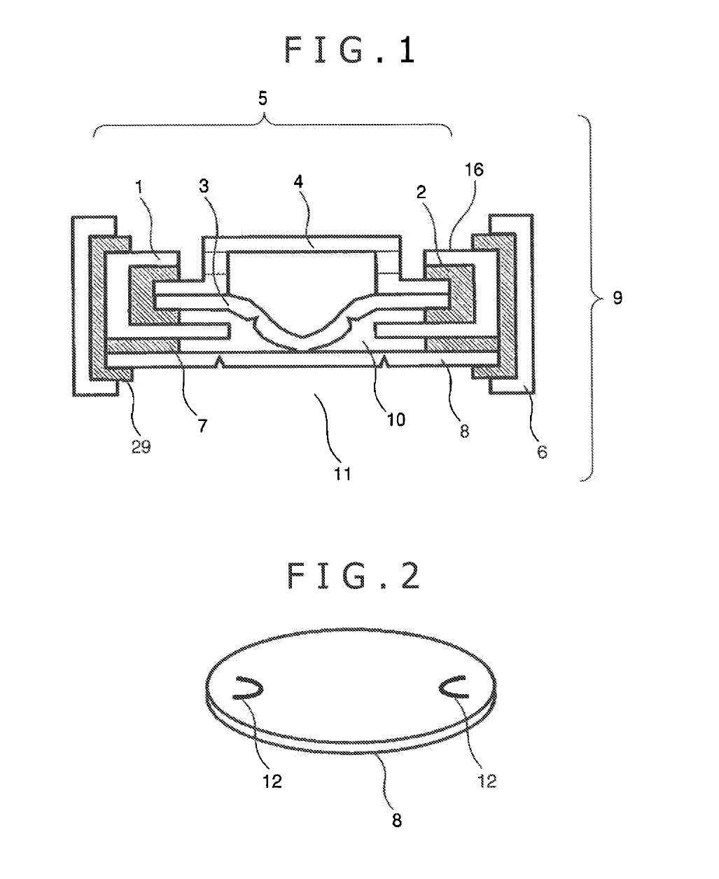

A can lid, as shown in a cross-sectional view of FIG. 1, is composed of a structure in which an inner frame structure 5 is surrounded by an outer frame 6.

In the first step, a second inner pressure sensing plate 3 was laminated under a top cap 4 with the inner frame 1 and a packing 2 made of polypropylene in-between. The inner frame 1 was swaged to be stabilized, thereby obtaining the inner frame structure 5.

Second, the inner frame structure 5, a ring-shaped packing 7 made of polypropyrene, and a first inner pressure sensing plate 8 were laminated in this order with the outer frame 6 and a packing 29 made of polyprophylene in-between. The outer frame 6 was swaged to be stabilized, thereby obtaining a can lid 9.

In the next step, to obtain electrical contact between the first inner pressure sensing plate 8 and the second inner pressure sensing plate 3, both of them were subjected to laser welding by using a metallic lead. The welding was carried out only at one point so that a welding point was cut by reversing a reverse portion 13 of the second inner pressure sensing plate 3.

Here, any hole is not present in the first inner pressure sensing plate 8, and for this reason, a space 10 and a space 11 are separated from each other with the first inner pressure sensing plate 8 in-between.

When a cleavage pressure (P1) of a cleavage portion 12 of the first inner pressure sensing plate 8 of the can lid 9 thus obtained, and a reverse pressure (P2) of the reverse portion 13 of the second inner pressure sensing plate 3 were measured, P1 and P2 were both 0.9 Mpa. Here, comparing P1 and P2 with a conventional can lid structure, although P2 corresponds to a pressure at which the current cutoff mechanism is actuated, no pressure corresponding to P1. A gas releasing mechanism for releasing as at a higher pressure than the reverse pressure (P2) may be provided on the second inner pressure sensing plate 3, as insurance for avoiding the rupture of the battery when the battery gets into a situation in which the rise of the battery inner pressure does not stop even after the current cutoff mechanism is actuated due to some sort of trouble.

A 0.3-millimeter-thick aluminum was used for the inner frame 1 and the outer frame 6, and a 0.1-millimeter-thick aluminum was used for the first inner pressure sensing plate 8 and the second inner pressure sensing plate 3. In addition, a cut 14 of the cleavage portion 12 of the first inner pressure sensing plate 8 was provided by press working. A 0.3-millimeter-thick aluminum with a cold-rolled steel strip being nickel-plated thereof was used for a top cap 4.

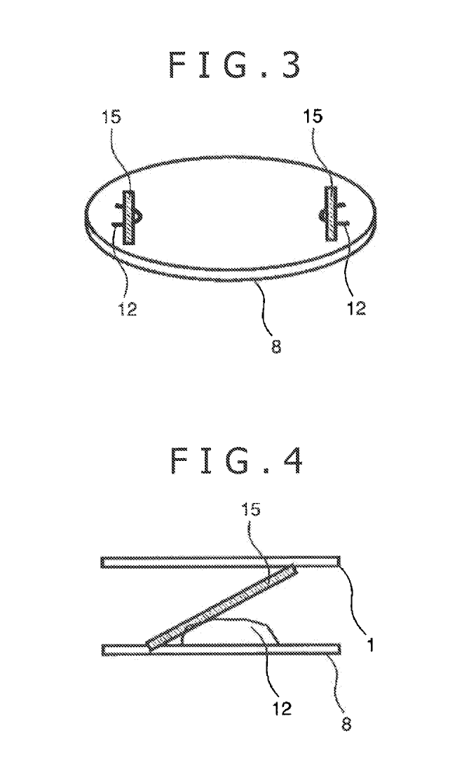

In the press working for the first inner pressure sensing plate 8, a shape of the cut 14 needs to be adjusted in such a way that the cleavage portion 12 is folded to a side facing the inner frame 1 and thus the cleavage portion 12 comes in electric contact with the inner frame 1 when the cleavage portion 12 is cleaved. As shown in FIG. 2, plural cleavage portions 12 are preferably provided on the first inner pressure sensing plate 8. By providing the plural cleavage portions 12, it is possible to cope with a case where any of the cleavage portions 12 is not actuated at the predetermined pressure too, for example, due to a mistake(s) in. the press working. As shown in FIG. 3, a subsidiary plate 15 made of a conductive material may be provided on a side surface of the first inner pressure sensing plate 8 on a side facing the inner frame 1 in such a way that the subsidiary plate 15 comes in contact with the side surface of the first inner pressure sensing plate 8 in the phase of the cleavage of the cleavage portion 12. A part of the subsidiary plate 15 is fixed to the first inner pressure sensing plate 8 by welding or other method. By providing the subsidiary plate 15, even when the folding of the cleavage portion 12 due to the cleavage is small, as shown in FIG. 4, the electrical contact between the first inner pressure sensing plate 8 and the inner frame 1 can be reliably obtained through the subsidiary plate 15. The subsidiary plate 15 is called the conductive material as well.

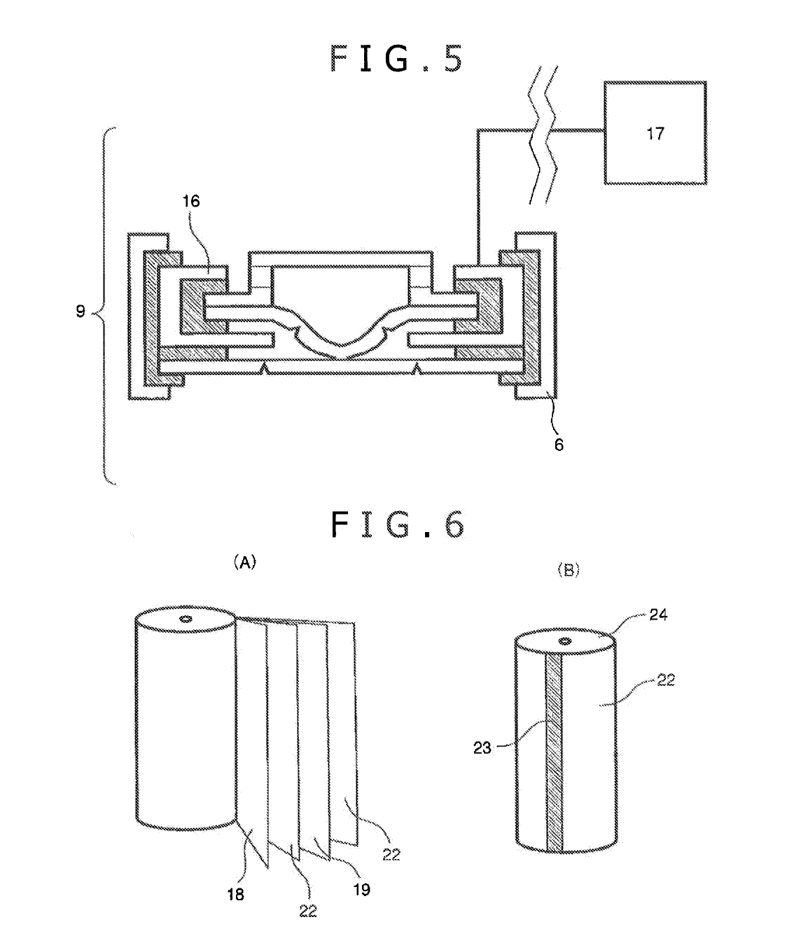

A portion 16 exposed from the packing is preferably provided in the inner frame 1 as shown in FIG. 1. By providing the exposed portion 16, for example, as shown in FIG. 5, an external circuit 17 can be connected to the exposed portion 16. A battery system thereby can be constructed which is able to constantly monitor the battery state. In addition, the external circuit 17 incorporated in the battery system is used as a discharging element, whereby the overcharged-state battery after the actuation of the current cutoff mechanism will be able to discharge.

### Making Electrode

LiNi_{0.33}Mn_{0.33}Co_{0.33}O₂ as a positive-electrode active material, powdered carbon as a conducting agent, and a polyvinyliden fluoride (PVDF) as a binding agent were measured at a weight ratio of 85:10:5, and a suitable amount of N-methyl-pyrrolidone (NMP) was added as a solvent thereto. The solution was mulled for 30 min by using a mulling mechanism, thereby obtaining positive-electrode slurry. The resulting positive-electrode slurry was applied to both surfaces of an aluminum foil (having a thickness of 20 μm and a width of 56 mm), thereby obtaining a positive-electrode sheet 18. Natural graphite, powdered carbon, and PVDF were used as a negative-electrode active material, the conducting agent, and the binding agent, respectively, and a suitable amount of NMP was added as the solvent thereto. The solution was mulled at a weight ratio of the negative-electrode active material:the conducting agent:and the binding agent=90:5:5 by the same manufacturing method as the manufacturing method for the positive electrode, thereby obtaining negative-electrode slurry. The resulting negative-electrode slurry was applied to both surfaces of a copper foil (thickness of 10 μm, width of 57 mm), thereby obtaining a negative-electrode sheet 19.

### Making Electrode Winding Body

After the positive-electrode electric collector lead portion 20 made of aluminum, and a negative-electrode electric collector lead portion 21 made of nickel were welded to the positive-electrode sheet 18 and the negative-electrode sheet 19, respectively, both of the electrodes were subjected to roll molding at 13 t to 14 t by using a pressing machine. Then, the resulting members were subjected to vacuum drying at 120° C. for 3 hours. After the drying, the positive-electrode sheet 18 and the negative-electrode sheet 19 were wound in the manner as shown in FIG. 6 through a separator 22 (polyethylene porous medium: thickness of 30 μm, porosity of 70%, width of 58 mm), and a separator end surface of an outer periphery of the winding body was fixed with a KAPTON® tape, thereby obtaining an electrode winding body 24.

### Making Cylindrical Secondary Battery

After the electrode winding body 24 was inserted into a cylindrical can 25, the negative-electrode electric collector lead portion 21 was resistance-welded to bottom of a can. Next, to obtain the electrical contact between the first inner pressure sensing plate 8, and the positive-electrode electric collector lead portion 20 extending from the electrode winding body 24, both of them were subjected to the resistance-welding. Also, after an electrolyte (created by dissolving LiPF₆ in a liquid solution in which ethylene carbonate (EC):1,2-dimethoxy ethane (EMC)=1:3 so as to obtain a concentration of 1M of LiPF₆) was injected, the can lid 9 was sealed by swaging the can, thereby obtaining a cylindrical secondary battery 26 according to the present invention.

### Voltage Detection And Discharge In Battery After Actuation of Current Cutoff Mechanism

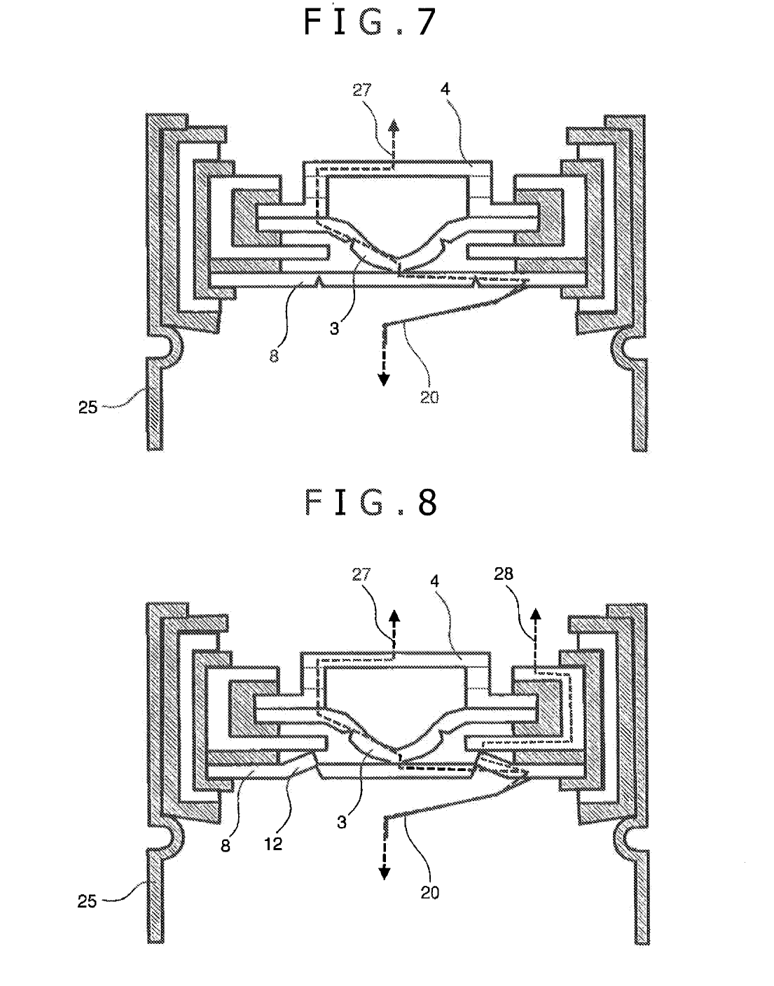

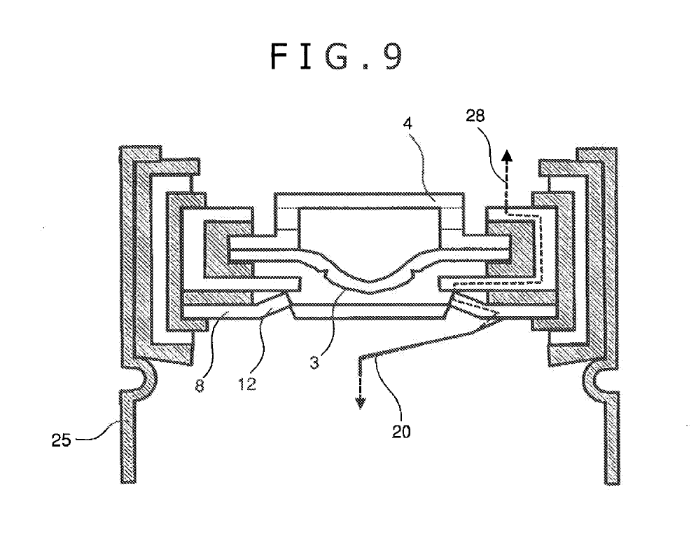

FIG. 7 to FIG. 9 show a part of a cross section in which the cylindrical secondary battery 26 is cut in a longitudinal direction of the cylindrical can 25. FIG. 7 shows a cross-sectional shape in a normal phase, FIG. 8 shows a cross-sectional shape when a battery inner pressure rises so that the cleavage portion 12 of the first inner pressure sensing plate 8 is cleaved, and FIG. 9 shows a cross-sectional shape when the reverse portion 13 of the second inner pressure sensing plate 3 is reversed, which follows the state of FIG. 8. Note that, making comparison with the conventional battery, the reverse of the reverse portion 13 of the second inner pressure sensing plate 3 in FIG. 9 denotes the actuation of the current cutoff mechanism.

Here, a dotted line 27 with an arrow (current path A27) linking the electrode winding body—the electric collector tab—the first inner pressure sensing plate—the welded portion—the second inner pressure sensing plate—the top cap shown in FIG. 7 and FIG. 8, and a dotted line 28 with an arrow (current path B28) linking the electrode winding body—the electric collector tab—the first inner pressure sensing plate—the cleavage portion—the inner frame shown in FIG. 8 and FIG. 9 indicate the current paths, respectively. The top cap 4 is called a first metal portion as well, and the inner frame 1 is called a second metal portion as well. The current path which is used for the normal charge and discharge is the current path A27, and the current path which is used for the voltage measurement and the discharge after the actuation of the current cutoff mechanism is the current path B28. The welded portion in the current path A27 corresponds to a pressure mechanism B, and the cleavage portion 12 in the current path B28 corresponds to a pressure mechanism A. The metal portion B and the electrode winding body 24 composing the current path B28 do not contact each other in the normal phase. The electrical contact between. the metal portion B and the electrode winding body 24 is caused only after the cleavage portion 12 and the inner frame 1 come in contact with each other when the cleavage portion 12 is cleaved by the inner pressure.

For a cleavage pressure (P1) of the cleavage portion 12 of the first inner pressure sensing plate 8, and an actuation (reverse) pressure (P2) of the second inner pressure sensing plate 3, although not being definite, a relationship of P1≧P2 preferably holds. This relationship holds, whereby the reverse portion 13 of the second inner pressure sensing plate 3 can be reversed instantly after the cleavage of the cleavage portion 12 of the first inner pressure sensing plate 8. The opening of the current path B28 due to the cleavage of the cleavage portion 12 of the first inner pressure sensing plate 8 shown in FIG. 8, and the cutoff of the current path A27 due to the actuation of the current cutoff mechanism shown in FIG. 9 can be simultaneously operated as well regarding the substantive timing.

In a case where the discharging element is incorporated in the current path B28, thereby constructing the battery system, P1≧P2 is set, which results in that the flowing of the current from an external load connected to the current path A27 to the discharging element into the current path B28 can be kept to the minimum, and the discharging element can be simplified. For example, the discharging element can also be composed of only a simple resistive element or a secondary battery. In addition to the resistive element or the secondary battery, a miniature bulb and an acoustic sound alarm can be mounted to disseminate that the current is flowing into the charging element when the battery is overcharged.

Such simplification of the discharging element cannot be realized with conventional compositions. That is to say, with the conventional configurations, in addition to the current path through the top cap 4 (hereinafter, a current path C. Making comparison with this embodiment, it corresponds to the current path A), the current path through a cap frame (hereinafter, a current path D. Making comparison with this embodiment, it corresponds to the current path B) is present. Since the current path D electrically contacts the electrode winding body 24 from the normal phase, if the simple resistive element or the secondary battery is connected to the current path D, the load applied to the current path C would spread to the current path D as well. If the discharging element were connected to the current path D with a conventional composition, the battery system composition would be complicated with. a large number of control circuits needed. The reasons are it is required to monitor if the current path C is not in an overcharged state in addition to providing a circuit with a mechanism that cuts an influence of the load applied to the current path C in a normal phase. Further, discharging, for example, must be carried out in the current path D when the current path C is in an overcharged state.

### Confirmation of Presence Or Absence of Actuation of Current Cutoff Mechanism

After the current cutoff is detected in the current path A27, the voltage of the current path B28 is observed by using the exposed portion 16 of the inner frame 1 of the can lid 9, making it possible to perform the measurement of the battery voltage, and the discharge. By the observation of voltage of the current path B, presence or absence of the actuation of the inner pressure sensitive current cutoff mechanism can be detected. cl DESCRIPTION OF REFERENCE NUMERALS
1 inner frame
2, 7, 29 packing made of polypropylene
3 second inner pressure sensing plate
4 top cap
5 inner frame structure
6 outer frame
8 first inner pressure sensing plate
9 can lid
10, 11 space
12 cleavage portion
13 reverse portion
14 cut
15 subsidiary plat
16 exposed portion
17 external circuit
18 positive-electrode sheet
19 negative-electrode sheet
20 positive-electrode electric collector lead portion
21 negative-electrode electric collector lead portion
22 separator
23 KAPTON® tape
24 electrode winding body
25 cylindrical can
26 cylindrical secondary battery
27 current path A
28 current path B

1. A cylindrical secondary battery in which a battery can having an electrode winding body is sealed with a can lid, wherein
said can lid has a current cutoff mechanism, a metal portion provided in a position exposed to an outside of said battery, and an inner pressure sensing portion provided on a side of said electrode winding body;
said inner pressure sensing portion has a cleavage portion which is cleaved by rise of a battery inner pressure; and
said metal portion does not electrically contact said electrode winding body before the cleavage of said cleavage portion, and is electrically connected to said electrode winding body after the cleavage of said cleavage portion.

2. The cylindrical secondary battery according to claim 1, wherein
P1≧P2 holds between a cleavage pressure (P1) of said cleavage portion and an actuation pressure (P2) of said current cutoff mechanism.

3. A cylindrical secondary battery in which a battery can having an electrode winding body is sealed with a can lid, wherein
said can lid has a first metal portion and a second metal portion which are provided in respective positions exposed to an outside of said battery, a first inner pressure sensing portion provided on a side of said electrode winding body, and a second inner pressure sensing portion provided between said first inner pressure sensing portion and said first metal portion;
said first inner pressure sensing portion has a cleavage portion which is cleaved by rise of a battery inner pressure;
said first metal portion is electrically connected to said electrode winding body through said first inner pressure sensing portion and said second inner pressure sensing portion; and
said second metal portion does not electrically contact said electrode winding body before the cleavage of said cleavage portion, and is electrically connected to said electrode winding body after the cleavage of said cleavage portion.

4. The cylindrical secondary battery according to claim 3, wherein
said second inner pressure sensing portion is welded to said first inner pressure sensing portion.

5. The cylindrical secondary battery according to claim 4, wherein
said second inner pressure sensing portion has a reverse portion which is reversed in accordance with rise of a battery inner pressure; and
the reverse of said reverse portion cuts a welded point between said first inner pressure sensing portion and said second inner pressure sensing portion.

6. The cylindrical secondary battery according to claim 3, wherein
said cleavage portion is folded to a side facing said second metal portion after the cleavage of said cleavage portion, which results in that said second metal portion is electrically connected to said electrode winding body.

7. The cylindrical secondary battery according to claim 3, wherein
an insulation portion is interposed between said first metal portion and said second metal portion.

8. The cylindrical secondary battery according to claim 3, wherein
P1≧P2 holds between a cleavage pressure (P1) of said cleavage portion, and a reverse pressure (P2) of said reverse portion.

9. A battery system having said cylindrical secondary battery according to claim 1, and a discharging element electrically connected to said metal portion, wherein
when said cleavage portion is cleaved, a current flows from said cylindrical secondary battery to said discharging element.

10. The battery system according to claim 9, wherein
said discharging element is any one of a resistive element, a secondary battery, an acoustic sound alarm, and a luminous body.

11. A battery system having said cylindrical secondary battery according to claim 3, and a discharging element electrically connected to said second metal portion, wherein
when said cleavage portion is cleaved, a current flows from said cylindrical secondary battery to said discharging element.

12. The battery system according to claim 11, wherein
said discharging element is any one of a resistive element, a secondary battery, an acoustic sound alarm, and a luminous body.
